(19) United States
(12) Patent Application Publication
(10) Pub. No.: US 2017/0136853 A1
(43) Pub. Date: May 18, 2017

(54) AIR BOX COVER WITH INTEGRAL AIR FLOW STRAIGHTENER PATTERN

(71) Applicant: FORD GLOBAL TECHNOLOGIES, LLC, Dearborn, MI (US)

(72) Inventors: Darren Edwin Garey, Grosse Pointe Park, MI (US); Chris B. Bishop, South Lyon, MI (US); Roger Joseph Khami, Troy, MI (US); David J. Rankel, Dearborn, MI (US)

(21) Appl. No.: 14/943,392

(22) Filed: Nov. 17, 2015

(51) Int. Cl. B60H 3/06

(52) U.S. Cl. CPC B60H 3/0658

(57) ABSTRACT

An air box cover is provided. That air box cover includes a one-piece body having an air filter outlet and an integral air flow straightener pattern extending across that air filter outlet. A plurality of vanes may form the air flow straightener pattern. At least one of those vanes may be of increased thickness to provide flow runner function when molding the air box cover in order to influence fill pattern and push gas toward venting locations during molding.

### TECHNICAL FIELD

This document relates generally to the motor vehicle equipment field and, more particularly, to an air box cover including an air filter outlet and an integral air flow straightener vane pattern extending across that air filter outlet.

### BACKGROUND

Disclosed and described herein is an air box cover that is molded as a one-piece body including both an air flow outlet and an integral air flow straightener vane pattern that extends across the air filter outlet. Advantageously, such an air box cover is relatively inexpensive to produce. More specifically, it eliminates the need to manufacture a separate flow straightener and then assemble that flow straightener into the air filter outlet of the air box cover as has been done in the past. Further, by combining flow runner function into the plurality of vanes forming the air flow straightener pattern, molding failure modes are substantially eliminated.

### SUMMARY

In accordance with the purposes and benefits described herein, an air box cover is provided. That air box cover comprises a one-piece body including an air filter outlet and an integral air flow straightener pattern extending across that air filter outlet. A plurality of vanes may form the air flow straightener pattern.

At least one vane of that plurality of vanes may be provided with an increased thickness to provide flow runner function when molding the air box cover. In one possible embodiment, at least three vanes of the plurality of vanes are increased in thickness to provide flow runner function when molding the air box cover.

In one possible embodiment the plurality of vanes are of varying thickness. In one possible embodiment the plurality of vanes are of varying pattern. In one possible embodiment, the plurality of vanes are of varying thickness and varying pattern.

In one possible embodiment, the air filter outlet is obround in shape. The air flow straightener pattern may also be obround in shape.

In accordance with an additional aspect, a method is provided for making an air box cover. That method may be broadly described as comprising the step of molding the air box cover with an integral air flow straightener pattern across an air filter outlet of the air box cover.

The method may include the step of forming the integral air flow straightener pattern from a plurality of vanes. Further, the method may include combining flow runner function into the plurality of vanes.

Thus, in some embodiments, the method may include thickening specific vanes of the plurality of vanes in order to influence fill pattern and push gas to mold venting locations during molding.

In the following description, there are shown and described several preferred embodiments of the air box cover. As it should be realized, the air box cover is capable of other, different embodiments and its several details are capable of modification in various, obvious aspects all without departing from the air box cover as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the air box cover and together with the description serve to explain certain principles thereof. In the drawing figures:

FIG. 1 is a perspective view from above the air box cover clearly showing the plurality of vanes that are integrally formed as a part of the air box cover and provide air flow straightener function.

FIG. 2 is a bottom perspective view of the air box cover illustrated in FIG. 1.

FIG. 3 is a detailed perspective view of one possible embodiment of the air box cover including three vanes of the integral air flow straightener pattern that are made with increased thickness to provide flow runner function when molding the air box cover.

FIG. 4 is a perspective view of yet another alternative embodiment of the air box cover wherein four vanes of the integral air flow straightener pattern are made of increased thickness to provide flow runner function when molding the air box cover.

Reference will now be made in detail to the present preferred embodiments of the air box cover, examples of which are illustrated in the accompanying drawing figures.

### DETAILED DESCRIPTION

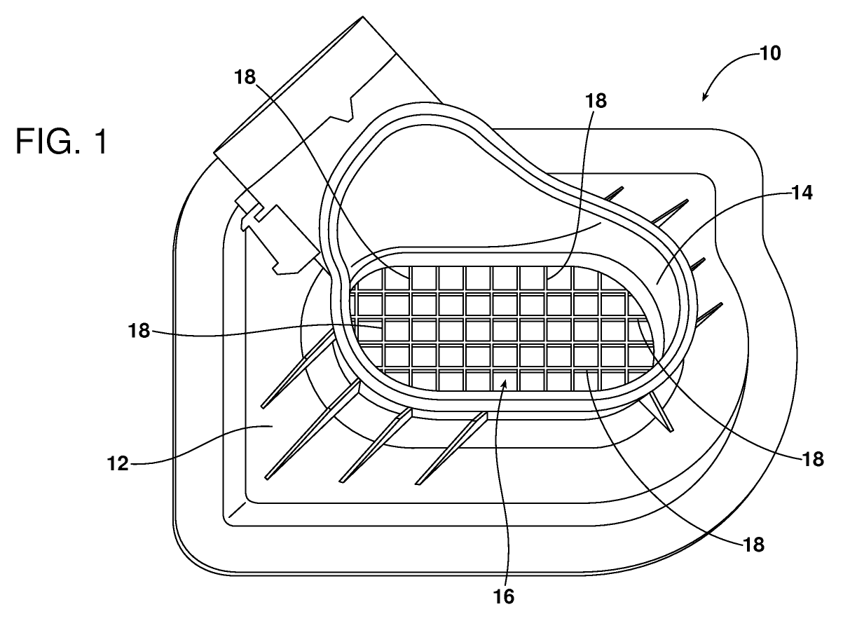

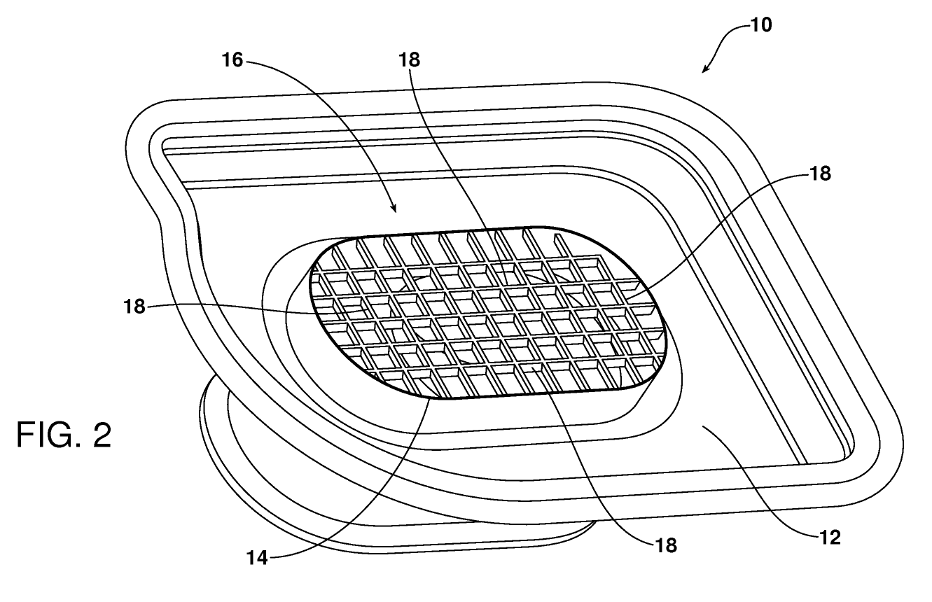

Reference is now made to FIGS. 1 and 2 illustrating an air box cover 10 including a one-piece body 12. That one-piece body 12 includes an air filter outlet 14 and an integral air flow straightener pattern 16 extending across the air filter outlet.

In the illustrated embodiment the air filter outlet 14 is obround in shape. Further, a plurality of vanes 18 form the air flow straightener pattern 16. That pattern 16 is also obround in shape so as to extend completely across the air filter outlet 14.

The integral one-piece body 12 of the air box cover 10 may be economically made by injection molding. Significantly, by combining flow runner function into the air flow straightening vanes 20, it is possible to greatly reduce any gas trapped during the injection molding process to the extent that any residual gas left may be removed through conventional venting processes thereby virtually eliminating any possibility of short shot (incomplete fill). This improves production efficiencies, eliminates waste materials and reduces overall production costs.

Flow runner function is provided by selecting specific vanes 18 and thickening them as needed to influence the fill pattern to push gas to venting locations during the injection molding process.

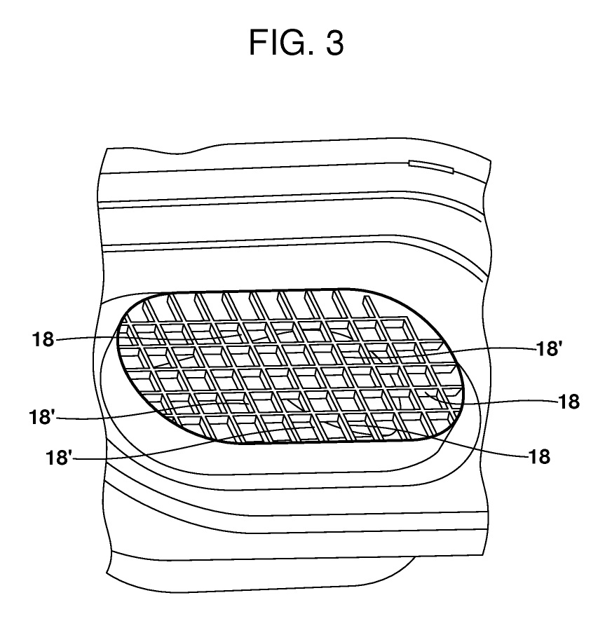

In the embodiment of the air box cover 10 illustrated in FIG. 3, three vanes, indicated by reference number 18′, extending across the width of the air flow outlet 14 are thickened relative to the other vanes 18 so as to provide flow runner function. As illustrated the thickened vanes 18′ alternate with the regular vanes 18.

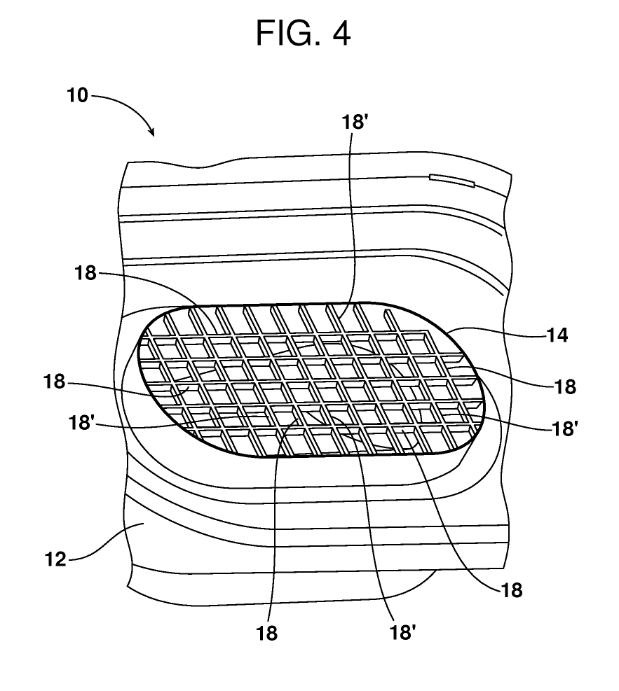

In the embodiment illustrated in FIG. 4, four vanes 18′ extending across the width of the air filter outlet 14 have been thickened relative to the other vanes 18 in order to provide flow runner function. Again, in this illustration, the thickened vanes 18′ alternate with the vanes 18 of regular thickness.

In any of the embodiments, vanes 18′ providing flow runner function generally have a cross-sectional area between 14.07 mm² and 19.71 mm² times that of the regular vanes 18. Thus, for example, where the vanes 18 and 18′ are equal in height, the vanes 18 could have a thickness of between about 1.7 mm and 2.3 mm while the vanes 18′ could have a greater thickness of between 2.1 mm and 2.7 mm.

It should be appreciated that other flow runner vane configurations are contemplated and are considered to be part of this disclosure. Accordingly, it should be appreciated that substantially any air box cover 10 incorporating a plurality of air flow straightener vanes 18 of varying thickness, varying pattern or varying thickness and pattern are possible. Further, while the air flow straightener function of the vanes 18′ of the embodiments illustrated in FIGS. 3 and 4 extend across the width of the obround shaped air flow outlet 14, it should be appreciated that one or more flow runner functioning vanes may also extend across the length of the obround air filter outlet if desired. The vanes 18′ selected for thickening in order to function in a flow runner capacity are largely determined by the positioning of the vent openings in the mold utilized in the injection molding of the air box cover 10.

Further, while the illustrated embodiments of the air box cover 10 include an air filter outlet 14 of obround shape, it should be appreciated other shapes are possible and are also covered by the claims presented at the end of this document.

A method of making an air box cover 10 is also disclosed herein. That method may be broadly described as comprising the step of molding the air box cover 10 with an integral air flow straightener pattern 16 extending across an air filter outlet 14 of the air box cover.

That method also includes the step of forming the integral air flow straightener pattern 16 from the plurality of vanes 18. This includes combining flow function into one or more of those plurality of vanes 18. Thus one or more vanes 18′ are thickened in order to influence a fill pattern to push gas to venting locations during the molding process.

The foregoing has been presented for purposes of illustration and description. It is not intended to be exhaustive or to limit the embodiments to the precise form disclosed. Obvious modifications and variations are possible in light of the above teachings. For example, while FIGS. 3 and 4 disclose air box covers 10 with thickened vanes 18′ that alternate with vanes 18 of regular thickness, it should be appreciated that other patterns could be provided such as two thickened vanes 18′ between two vanes 18 of regular thickness. Further, the arrangement of the vanes 18′, 18 may be patternless. The number, orientation and arrangement of the thickened vanes 18′ providing flow runner function is driven by the mold used to mold the air box cover 10 and the locations of vents in that mold. All such modifications and variations are within the scope of the appended claims when interpreted in accordance with the breadth to which they are fairly, legally and equitably entitled.

What is claimed:

1. An air box cover, comprising:
a one-piece body including an air filter outlet and an integral air flow straightener pattern extending across said air filter outlet.

2. The air box cover of claim 1 including a plurality of vanes forming said air flow straightener pattern.

3. The air box cover of claim 2, wherein at least one vane of said plurality of vanes is of increased thickness to provide flow runner function when molding said air box cover.

4. The air box cover of claim 2, wherein at least three vanes of said plurality of vanes are of increased thickness to provide flow runner function when molding said air box cover.

5. The air box cover of claim 2, wherein said plurality of vanes are of varying thickness.

6. The air box cover of claim 5, wherein said plurality of vanes are of varying pattern.

7. The air box cover of claim 2, wherein said plurality of vanes are of varying pattern.

8. The air box cover of claim 1, wherein said air filter outlet is obround in shape.

9. The air box cover of claim 8, wherein said air flow straightener pattern is obround in shape.

10. The air box cover of claim 9, including a plurality of vanes forming said air flow straightener pattern.

11. The air box cover of claim 10, wherein at least one vane of said plurality of vanes is of increased thickness to provide flow runner function when molding said air box cover.

12. A method of making an air box cover, comprising:
molding said air box cover with an integral air flow straightener pattern across an air filter outlet of said air box cover.

13. The method of claim 12, including forming said integral air flow straightener pattern from a plurality of vanes.

14. The method of claim 13, including combining flow runner function into said plurality of vanes.

15. The method of claim 14, including thickening specific vanes of said plurality of vanes in order to influence fill pattern and push gas to venting locations during molding.
